(19) United States
(12) Patent Application Publication
(10) Pub. No.: US 2013/0286580 A1
(43) Pub. Date: Oct. 31, 2013

(54) HEAT DISSIPATION ASSEMBLY AND SERVER USING THE SAME

(71) Applicants: HONG FU JIN PRECISION INDUSTRY (ShenZhen) CO., LTD., (US); HON HAI PRECISION INDUSTRY CO., LTD., (US)

(72) Inventors: XIAO-FENG MA, Shenzhen (CN); CHIA-SHIN CHOU, New Taipei (TW)

(73) Assignees: HONG HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/728,520

(22) Filed: Dec. 27, 2012

(30) Foreign Application Priority Data
Apr. 26, 2012 (CN) 201210125601.6

(51) Int. Cl. F28F 23/00; G06F 1/20

(52) U.S. Cl. CPC F28F 23/00; G06F 1/20
USPC 361/679.47; 165/121

(57) ABSTRACT

A heat dissipation assembly includes a housing, a number of fans, and an exhaust apparatus. The housing defines a receiving groove and an opening intercommunicating with the receiving groove. The fan is received in the receiving groove and is used for heat dissipation. The exhaust apparatus is received in the receiving groove and is positioned adjacent to the opening. The exhaust apparatus draws airflow to form an air partition, the air partition prevents an airflow generated by the fans from going out of the housing through the opening.

### BACKGROUND

1. Technical field

The disclosure generally relates to heat dissipation assemblies used for servers.

2. Description of the Related Art

A typical server uses fans for dissipating heat produced by electronic components therein. The fans can direct cold airflow to air channels defined between the electronic components.

However, when the server is opened, the cold airflow from the fans might go directly out of the server. The electronic components might not have their heat effectively dissipated when in the open state.

Therefore, there is room for improvement within the art.

### BRIEF DESCRIPTION OF THE DRAWINGS

Many aspects of an exemplary heat dissipation assembly can be better understood with reference to the following drawings. The components in the drawings are not necessarily drawn to scale, the emphasis instead being placed upon clearly illustrating the principles of the exemplary heat dissipation assembly. Moreover, in the drawings, like reference numerals designate corresponding parts throughout the several views. Wherever possible, the same reference numbers are used throughout the drawings to refer to the same or like elements of an embodiment.

FIG. 1 is a schematic view illustrating an internal structure of a server using a heat dissipation assembly, according to an exemplary embodiment.

FIG. 2 is a schematic view of the server shown in FIG. 1.

FIG. 3 is a cross section view of the server shown in FIG. 2 taken along line III-III.

FIG. 4 is similar to FIG. 3, without a removable cover shown in FIG. 3.

### DETAILED DESCRIPTION

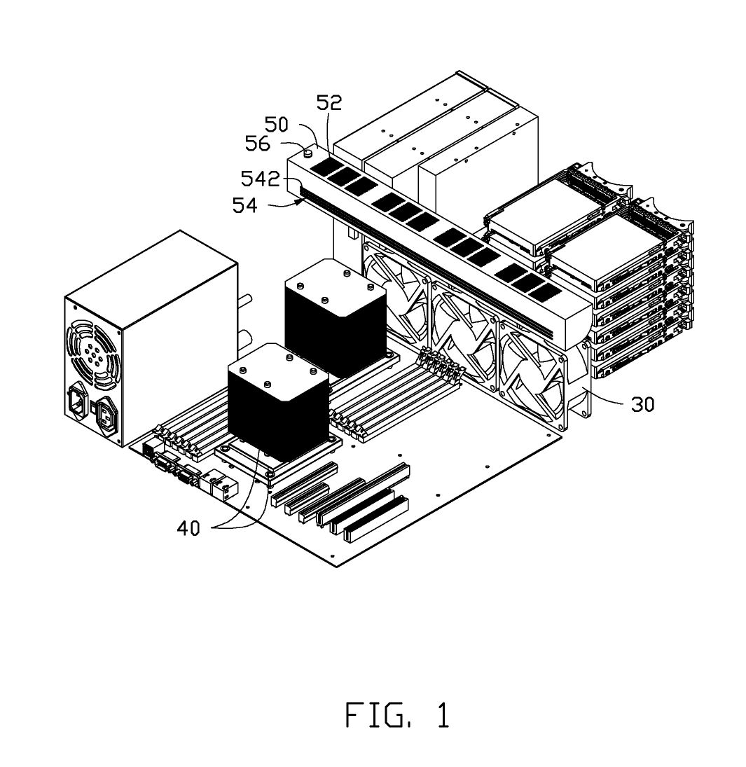

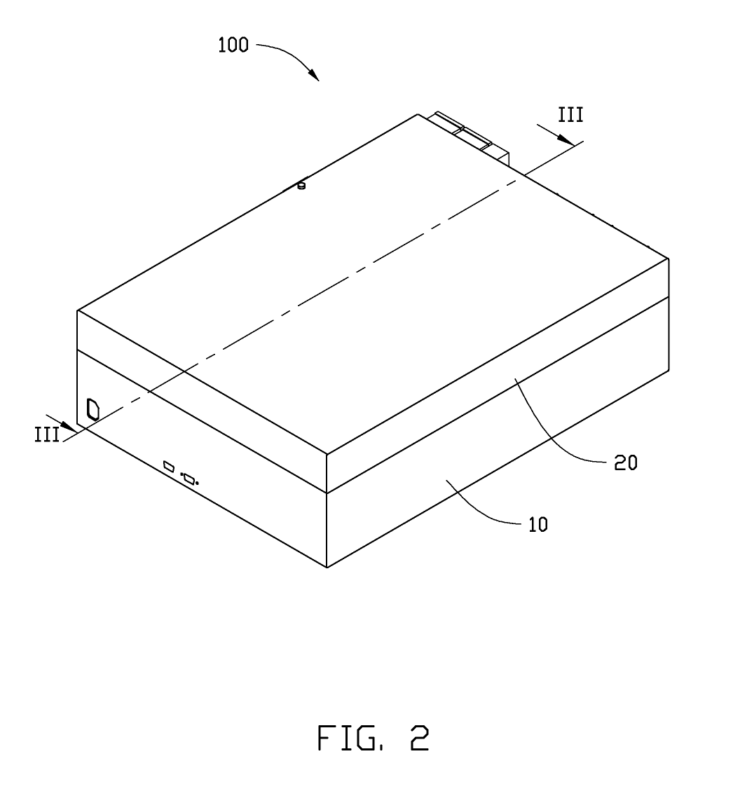

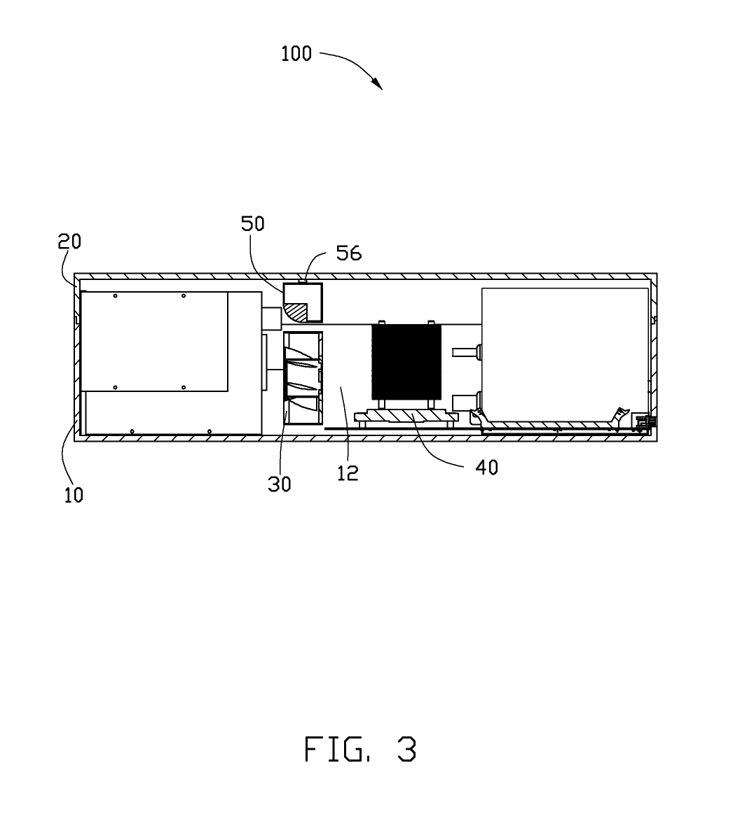

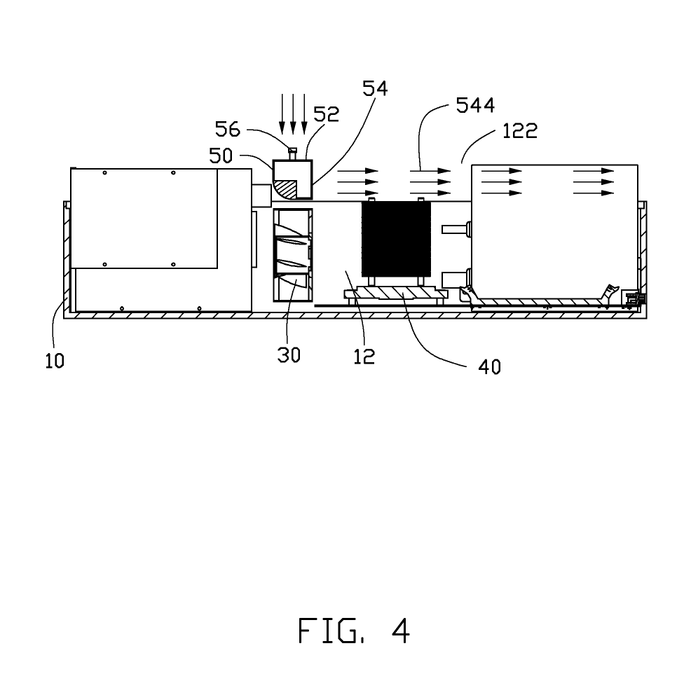

FIG. 1 and FIG. 2 show an exemplary embodiment of a device. The device is using a heat dissipation assembly. In this embodiment, the device is a server 100. The heat dissipation assembly includes a housing 10, a removable cover 20, a plurality of fans 30, a plurality of electronic components 40, and an exhaust apparatus 50. Referring to FIG. 3 and FIG. 4, the housing 10 defines a receiving groove 12 and an opening 122 communicating with the receiving groove 12. The plurality of fans 30, the plurality of electronic components 40, and the exhaust apparatus 50 are received in the receiving groove 12. The removable cover 20 covers the opening 122. The plurality of fans 30 dissipate the heat generated by the plurality of electronic components 40. In this embodiment, the plurality of fans 30 are aligned along a straight line and are located at a side of the electronic components 40; the electronic components 40 include a central processing unit and hard disks.

The exhaust apparatus 50 is located above the plurality of fans 30 and includes an entrance 52 and an exit 54 intercommunicating with the entrance 52. Cold air is drawn into the housing 10 by the exhaust apparatus 50 from the entrance 52, and exits through the exit 54. The exit 54 consists of a plurality of strip nozzles 542 parallel to each other. The plurality of strip nozzles 542 are parallel to the plurality of fans 30. A switch 56 is located adjacent to the entrance 52. When the removable cover 20 is covering the housing 10, the removable cover 20 presses the switch 56 to turn off the exhaust apparatus 50. Therefore, when the removable cover 20 is covering the housing 10, the electrical components 40 have their heat dissipated solely by the fans 30.

FIG. 3 and FIG. 4 shows that when the server 100 is working, the plurality of fans 30 are started and direct cold airflow to a desired path (not shown) defined in the receiving groove 12. If the removable cover 20 is opened, the switch 56 is activated to start the exhaust apparatus 50. The exhaust apparatus 50 draws airflow out of the housing 10 into the inside of the housing 10. The airflow in the exhaust apparatus 50 flow from the plurality of strip nozzles 542 to form an air partition 544, the air partition 544 is used for dividing the opening 122 with the receiving groove 12. The airflow from the plurality of fans 30 is blocked by the air partition 544 and cannot go out of the housing 10 through the opening 122.

In this embodiment, when the removable cover 20 is opened, the exhaust apparatus 50 generates an air partition to prevent airflow from the fans 30 to go out of the opening 122. The airflow from the plurality of fans 30 can be directed to the desired path even if the server 100 is opened. The heat dissipation efficiency of the server 100 is still kept.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A heat dissipation assembly, comprising:
a housing defining a receiving groove and an opening communicating with the receiving groove;
at least one fan received in the receiving groove and used for heat dissipation; and
an exhaust apparatus received in the receiving groove and located adjacent to the opening;
wherein the exhaust apparatus draws an airflow to form an air partition, the air partition prevents an airflow generated by the at least one fan from going out of the housing through the opening.

2. The heat dissipation assembly as claimed in claim 1, wherein the exhaust apparatus comprises an entrance and an exit intercommunicating with the entrance; cold air is drawn into the housing by the exhaust apparatus from the entrance, and exits through the exit.

3. The heat dissipation assembly as claimed in claim 2, wherein there are a plurality of fans and the plurality of fans are aligned along a straight line; the exit comprises a plurality of strip nozzles, the strip nozzles being parallel to the plurality of fans.

4. The heat dissipation assembly as claimed in claim 1, wherein the heat dissipation assembly further comprises a removable cover for covering the opening.

5. The heat dissipation assembly as claimed in claim 4, wherein the exhaust apparatus further comprises a switch adjacent to the removable cover, when the removable cover is covered on the housing, the removable cover presses the switch to turn off the exhaust apparatus; when the removable cover is opened, the switch is activated to start the exhaust apparatus.

6. A server, comprising:
a housing defining an opening;
a plurality of electronic components received in the housing;
a plurality of fans received in the housing for dissipating heat generated by the plurality of electronic components;
an exhaust apparatus received in the housing and located adjacent to the opening;
wherein the exhaust apparatus draws an airflow to form an air partition, the air partition prevents an airflow generated by the plurality of fans from going out of the housing through the opening.

7. The server as claimed in claim 6, wherein the exhaust apparatus comprises an entrance and an exit intercommunicating with the entrance; cold air is drawn into the housing by the exhaust apparatus from the entrance, and exits through the exit.

8. The server as claimed in claim 7, wherein the plurality of fans are aligned along a straight line; the exit comprises a plurality of strip nozzles, the strip nozzles are parallel to the plurality of fans.

9. The server as claimed in claim 6, wherein the server further comprises a removable cover for covering the opening.

10. The server as claimed in claim 9, wherein the exhaust apparatus further comprises a switch adjacent to the removable cover, when the removable cover is covered on the housing, the removable cover presses the switch to turn off the exhaust apparatus; when the removable cover is opened, the switch is activated to start the exhaust apparatus.
